(19) United States
(12) Patent Application Publication
(10) Pub. No.: US 2026/0052155 A1
(43) Pub. Date: Feb. 19, 2026

(54) SYSTEMS AND METHODS FOR IMPLEMENTING AUTOMATED AGENT AUTHENTICATION PROTOCOLS

(71) Applicant: Forter Ltd, New York, NY (US)

(72) Inventors: Iftah Gideoni, Kfar Vitkin (IL); Guy Zucker, Tel Aviv (IL)

(73) Assignee: Forter Ltd, New York, NY (US)

(21) Appl. No.: 19/298,562

(22) Filed: Aug. 13, 2025

Related U.S. Application Data
(60) Provisional application No. 63/684,236, filed on Aug. 16, 2024.
(60) Provisional application No. 63/684,249, filed on Aug. 16, 2024.

(51) Int. Cl. H04L 9/40; H04L 9/32

(52) U.S. Cl. CPC H04L 63/105; H04L 9/3263

(57) ABSTRACT

According to various embodiments, the integration of automated agents adds convenience and reduces time requirements on individuals, but also significantly magnifies security risks, including, for example, security risks in cases of fraud (e.g., unauthorized use of agents to purchase goods, agents masquerading as authorized, etc.). According to various embodiments, the transacting entity (the agent) can be supported by a security infrastructure that ensures the agent carries the reputation of the entity they are operating on behalf of, and provides immutable constraints on their operation. For example, the agent can operate based on the strength of authentication of its connection to the individual. In some embodiments, the security architecture can include delegation for chains of payment permissions, where agents create new sub-agents. The strength of the reputation required may vary by the type of agent and desired action, among other factors.

### RELATED APPLICATIONS

This application claims the benefit under 35 U.S. C. § 119(e) of U.S. Provisional Application No. 63/684,236, filed Aug. 16, 2024, and entitled “SYSTEMS AND METHODS FOR IMPLEMENTING AUTOMATED AGENT AUTHENTICATION PROTOCOLS,” which is herein incorporated by reference in its entirety. This application claims the benefit under 35 U.S. C. § 119(e) of U.S. Provisional Application No. 63/684,249, filed Aug. 16, 2024, and entitled “SYSTEMS AND METHODS FOR IMPLEMENTING AUTOMATED AGENT AUTHENTICATION PROTOCOLS,” which is herein incorporated by reference in its entirety.

### BACKGROUND

As the modern marketplace evolves to include more and more automation, more and more commercial transactions are executed without involving an individual.

### SUMMARY

The inventors have realized that these evolving uses of automation need a new security paradigm and improved technical integration to implement them. Such approaches are not currently available, and those that are related are insufficient for the scope and volume of the operations that need to be secured.

The inventors have realized that automated agents (“agent,” “bot,” etc.) will be implemented where those agents are configured to make decisions and conduct commerce on behalf of humans. Ultimately, the integration of agents adds convenience and reduces time requirements on individuals, but also significantly magnifies the security risks, including, for example, security risks in cases of fraud (e.g., unauthorized use of agents to purchase goods, agents masquerading as authorized, etc.). This may extend into fundamental changes with current merchant experiences and new approaches, security restrictions, and technical implementation to manage them (e.g., if a refrigerator makes an order while the owner is on vacation, what security is provided for validation and under what conditions is the purchaser (the refrigerator or the individual) allowed to return it).

According to various embodiments, the transacting entity (the agent) can be supported by security infrastructure that allows the agent to carry the reputation of the individual/human entity they are operating on behalf of. For example, the agent can operate based on the strength of authentication of its connection to the individual (e.g., including refresh/renewal operations that may occur periodically to maintain the secure connection). In some embodiments, the security architecture can include delegation for chains of payment permissions. In further examples, the strength of the reputation required may vary by the type of agent and desired action (e.g., based on exposure to different attack vectors, value of potential transaction, participant-imposed limitations on operations, etc.).

Furthermore, the security architecture can be configured to apply to non-payment transactions/operations that need to be secured, validated, and managed, as bots are leveraged for non-commerce tasks as well. Similar security, validation, and technical management considerations apply to non-payment operations that require identity assurance and/or authentication (e.g., this can occur whenever an agent is requesting to perform sensitive operations, receive data, and may include requests for sensitive data). The security architecture defines a framework that evolves with the agent ecosystem, and provides for integration of security, identity, validation, and/or authentication, and includes integration into partner systems, architecture, and management, and can, in some examples, be based on the sensitivity or security threat posed by a requested action or operation. This architecture represents a significant departure from conventional approaches that seek to identify agent operations specifically to prevent them. The present disclosure reverses the conventional security paradigm (e.g., block agent operation), and instead provides new technical implementation to secure and validate these operations.

According to some aspects, the security architecture and/or framework provides any one more or any combination of the following features: (a) ensure merchants can conduct proper Risk Based Authentication and that RBAs are relevant in the flow and provide merchants adequate protection (e.g., enables strong customer authentication (“SCA” to the end user even when agents are operating); and (b) balanced with users having “a good experience”—e.g., adequate protection to the users as part of the agent ecosystem, and reduced complexity in engaging and/or constraining agent operation. In further embodiments, the system secures operations that enable a merchant or its RBA service (or in other examples, any external authorized broker or agent) to access the human for further verification of the agent that acts on behalf of the human. For example, the handshake (e.g., information exchanged) for an agent with an external entity can be configured to contain the details for establishing contact/handshake with the human, or in other examples, to enable communication with the entity from which the authority to act was delegated to the agent. In some embodiments, the external entity, such as a merchant or broker, can trigger a security protocol that uses these contact details to climb the delegation chain up to a point of sufficient authority (e.g., where the external entity is provided validation/authentication assurance that the higher entity was well authenticated). In some examples, the system enables security escalation for agent operation, which enables the system to provide verification of the agent's identity and the agent's delegated authority details.

Various embodiments include any one or more or any combination of the following: agent presents the operation details to the merchant plus an encrypted certificate as defined by the protocol to identify the consumer, agent, and contract terms (e.g., encrypt data such as when contract was initiated, when the last user strongly authenticated approval for contract was given, the form of the SCA conducted, details about the agent, user login credential to allow “registered” state, user sign up details to enroll); participant (e.g., merchant) risk engine can trigger step up (e.g., SCA) directly for the user e.g. via email/phone passed from the agent; participant (e.g., merchant) Risk engine can trigger step up to the payment instrument owner e.g., [3DS “out of band challenge”]; agent being the trusted entity for triggering the authentication (acting in a similar role to the bank in 3DS.); participant risk engine configured to determine which challenge is triggered to avoid cumbersome end user friction (potentially three challenges noted above happening simultaneously).

Various embodiments include any one or more or any combination of the following: agent presents the operation details to the merchant plus an encrypted certificate as defined by the protocol to identify the consumer, agent, and contract terms (e.g., encrypt data such as when contract was initiated, when the last user strongly authenticated approval for contract was given, the form of the SCA conducted, details about the agent, user login credential to allow “registered” state, user sign up details to enroll); participant (e.g., merchant) risk engine can trigger step up (e.g., SCA) directly for the user e.g. via email/phone passed from the agent; participant (e.g., merchant) Risk engine can trigger step up to the payment instrument owner e.g., [3DS “out of band challenge”]; agent being the trusted entity for triggering the authentication (acting in a similar role to the bank in 3DS.); participant risk engine configured to determine which challenge is triggered to avoid cumbersome end user friction (potentially 3 challenges noted above happening simultaneously).

According to one aspect, a system for secure processing of agent-based operations, the system comprising at least one processor operatively connected to a memory, the at least one processor when executing configured to identify a secure operation initiated by an agent, evaluate at least one security requirement associated with the secure operation, based on at least one or any combination of: the secure operation, identification of the agent, security association between the agent and a human actor, merchant, payment modality, value associated with the secure operation, and sensitivity of the secure operation, and execute asynchronous or synchronous authentication based on the evaluation of the at least one security requirement.

According to one embodiment, the at least one processor is configured to evaluate a signature or certificate associated with the agent, and encode the at least one security requirement in the signature or certificate during registration of the agent. According to one embodiment, the at least one processor is configured to retrieve the signature or the certificate associated with the agent, wherein the signature or the certificate encodes a defined security level associated with the agent and version of the agent. According to one embodiment, the signature or the certificate associated with the agent immutably encodes any authorized operation associated with the agent and operational constraints imposed on the authorized operation. According to one embodiment, the at least one processor is configured to evaluate a timing associated with a last threshold security level (e.g., strong authentication) of authentication.

According to one embodiment, the at least one processor is configured to evaluate respective participant requirements in an execution architecture against a defined security level associated with the agent, any authorized operation associated with the agent, and operation constraints imposed on the authorized operation to determine compliance with the participant requirements. According to one embodiment, the at least one processor is configured to evaluate a first set of requirements imposed by a first set of participants in an execution architecture for a first agent configured to operate with the first set of participants. According to one embodiment, the at least one processor is configured to evaluate a second set of requirements imposed by a second set of participants in the execution architecture for a second agent configured to operate with the second set of participants. According to one embodiment, a respective agent is linked to a respective set of participants via a plugin or API connecting the respective agent to at least one member of the respective set of participants.

According to one aspect, a computer-implemented method for secure authentication of agent-based operations is provided. The method comprises identifying, by at least one processor, a secure operation initiated by an agent, evaluating, by at least one processor, at least one security requirement associated with the secure operation, based on at least one or any combination of: the secure operation, identification of the agent, security association between the agent and a human actor, merchant, payment modality, value associated with the secure operation, and sensitivity of the secure operation, and confirming, by the at least one processor, the at least one security requirement is met, or triggering enhanced security requests to meet the at least one security requirement.

According to one embodiment, the method comprises evaluating a signature or certificate associated with the agent; and retrieving or confirming secure operation constraints based on the signature or certificate. According to one embodiment, the method comprises retrieving the signature or the certificate associated with the agent, wherein the signature or the certificate encodes a defined security level associated with the agent and a version of the agent. According to one embodiment, the signature or the certificate associated with the agent immutably encodes any authorized operation associated with the agent and operational constraints imposed on the authorized operation. According to one embodiment, the signature or the certification includes encoding of the version of the agent to validate the respective version.

According to one embodiment, the method comprises evaluating a timing associated with a last threshold level of authentication. According to one embodiment, the method comprises evaluating respective participant requirements in an execution architecture against a defined security level associated with the agent, any authorized operation associated with the agent, and operation constraints imposed on the authorized operation to determine compliance with the participant requirements. According to one embodiment, the act of evaluating is further based on a respective agent version. According to one embodiment, the method comprises evaluating a first set of requirements imposed by a first set of participants in an execution architecture for a first agent configured to operate with the first set of participants. According to one embodiment, the method comprises evaluating a second set of requirements imposed by a second set of participants in the execution architecture for a second agent configured to operate with the second set of participants. According to one embodiment, a respective agent is linked to a respective set of participants via a plugin or API connecting the respective agent to at least one member of the respective set of participants. According to one embodiment, the method comprises triggering enhanced security requests to meet the at least one security requirement. According to one embodiment, the method comprises evaluating a chain of permissions for the agent operation from the agent to respective preceding delegations until a security threshold is met.

According to one aspect, a system for securing agent-based operations is provided. The system comprises at least one processor operatively connected to a memory, the at least one processor when executing configured to display an interface to an end user, the interface configured to establish under SCA the identity for the end user, register for agent initiated operations (e.g., secure transactions, data access, etc.), access requirements defined by operation processing participants (e.g., merchants, payment processors, authentication processors, access providers, etc.), accept end user defined constraints on agent authority, execute an authentication engine configured to generate a signature/identification certificate for a respective agent being registered, and generate execution triggers for enhancing security requirements based, at least in part, on the access requirements and the end user defined constraints.

According to one embodiment, the at least one processor is configured to evaluate a signature or certificate associated with the agent. According to one embodiment, the at least one processor is configured to encode the at least one security requirement in the signature or certificate during registration of the agent. According to one embodiment, the at least one processor is configured to retrieve the signature or the certificate associated with the agent, wherein the signature or the certificate encodes a defined security level associated with the agent and version of the agent. According to one embodiment, the signature or the certificate associated with the agent immutably encodes any authorized operation associated with the agent and operational constraints imposed on the authorized operation. According to one embodiment, the at least one processor is configured to evaluate a timing associated with a last threshold security level (e.g., strong authentication) of authentication. According to one embodiment, the at least one processor is configured to evaluate respective participant requirements in an execution architecture against a defined security level associated with the agent, any authorized operation associated with the agent, and operation constraints imposed on the authorized operation to determine compliance with the participant requirements.

According to one embodiment, the at least one processor is configured to evaluate a first set of requirements imposed by a first set of participants in an execution architecture for a first agent configured to operate with the first set of participants. According to one embodiment, the at least one processor is configured to evaluate a second set of requirements imposed by a second set of participants in the execution architecture for a second agent configured to operate with the second set of participants. According to one embodiment, a respective agent is linked to a respective set of participants via a plugin or API connecting the respective agent to at least one member of the respective set of participants.

According to one aspect, a computer implemented method for securing agent-based operations is provided. The method comprises displaying, by at least one processor, an interface to an end user, establishing, by the at least one processor, the identity for the end user under strong customer authentication “SCA” constraints, registering, by the at least one processor, the end user for agent initiated operations (e.g., secure transactions, data access, etc.), accessing, by the at least one processor, requirements defined by operation processing participants (e.g., merchants, payment processors, authentication processors, access providers, etc.), accepting, by the at least one processor, end user defined constraints on agent authority, generating, by the at least one processor, an identification for a respective agent being registered, and generating, by the at least one processor, execution triggers for enhancing security requirements based, at least in part, on the access requirements and the end user defined constraints.

According to one embodiment, the method comprises evaluating a signature or certificate associated with the agent. According to one embodiment, the method comprises encoding the at least one security requirement in the signature or certificate during registration of the agent. According to one embodiment, the method comprises retrieving the signature or the certificate associated with the agent, wherein the signature or the certificate encodes a defined security level associated with the agent and version of the agent. According to one embodiment, the signature or the certificate associated with the agent immutably encodes any authorized operation associated with the agent and operational constraints imposed on the authorized operation. According to one embodiment, the method comprises evaluating a timing associated with a last threshold security level (e.g., strong authentication) of authentication.

According to one embodiment, the method comprises evaluating respective participant requirements in an execution architecture against a defined security level associated with the agent, any authorized operation associated with the agent, and operation constraints imposed on the authorized operation to determine compliance with the participant requirements. According to one embodiment, the method comprises evaluating a first set of requirements imposed by a first set of participants in an execution architecture for a first agent configured to operate with the first set of participants. According to one embodiment, the method comprises evaluating a second set of requirements imposed by a second set of participants in the execution architecture for a second agent configured to operate with the second set of participants. According to one embodiment, a respective agent is linked to a respective set of participants via a plugin or API connecting the respective agent to at least one member of the respective set of participants.

Various embodiments include any one or more or any combination of the following: agent presents the operation details to the merchant plus an encrypted certificate as defined by the protocol to identify the consumer, agent, and contract terms (e.g., encrypt data such as when contract was initiated, when the last user strongly authenticated approval for contract was given, the form of the SCA conducted, details about the agent, user login credential to allow “registered” state, user sign up details to enroll); participant (e.g., merchant) risk engine can trigger step up (e.g., SCA) directly for the user e.g. via email/phone passed from the agent; participant (e.g., merchant) Risk engine can trigger step up to the payment instrument owner e.g. [3DS “out of band challenge”]; agent being the trusted entity for triggering the authentication (acting in a similar role to the bank in 3DS.); participant risk engine configured to determine which challenge is triggered to avoid cumbersome end user friction (potentially 3 challenges noted above happening simultaneously).

According to one embodiment, the at least one processor is configured to execute verification of an end user to establish agent operation authority. According to one embodiment, the at least one processor is configured to generate an identity ledger reflecting authentication or authorization information accessible by participant systems executing respective operations and third party systems. According to one embodiment, the at least one processor is configured to generate an identity ledger reflecting authentication or authorization information associated with respective agents accessible by participant systems executing respective operations and third party systems. According to one embodiment, the at least one processor is configured to generate the identity ledger to include trust information defining authentication or authorization information for agent classes and membership within respective classes. According to one embodiment, the at least one processor is configured to encode identity information and at least one signature, optionally a public key, associated with a human actor as primary authority for actions initiated by any associated agent in an authorization chain. According to one embodiment, the at least one processor is configured to execute a communication channel with the human actor to validate validity of any operation.

Still other aspects, examples, and advantages of these exemplary aspects and examples are discussed in detail below. Moreover, it is to be understood that both the foregoing information and the following detailed description are merely illustrative examples of various aspects and examples and are intended to provide an overview or framework for understanding the nature and character of the claimed aspects and examples. Any example disclosed herein may be combined with any other example in any manner consistent with at least one of the objects, aims, and needs disclosed herein, and references to “an example,” “some examples,” “an alternate example,” “various examples,” “one example,” “at least one example,” “this and other examples” or the like are not necessarily mutually exclusive and are intended to indicate that a particular feature, structure, or characteristic described in connection with the example may be included in at least one example. The appearances of such terms herein are not necessarily all referring to the same example.

### BRIEF DESCRIPTION OF THE DRAWINGS

Various aspects of at least one embodiment are discussed herein with reference to the accompanying figures, which are not intended to be drawn to scale. The figures are included to provide illustration and a further understanding of the various aspects and embodiments, and are incorporated in and constitute a part of this specification, but are not intended as a definition of the limits of the invention. Where technical features in the figures, detailed description, or any claim are followed by reference signs, the reference signs have been included for the sole purpose of increasing the intelligibility of the figures, detailed description, and/or claims. Accordingly, neither the reference signs nor their absence are intended to have any limiting effect on the scope of any claim elements. In the figures, each identical or nearly identical component that is illustrated in various figures is represented by a like numeral. For purposes of clarity, not every component may be labeled in every figure. In the figures:

FIG. 1 is a block diagram of an example system and environment in which an agent may execute operations on behalf of an end user, according to one embodiment;

FIG. 2 shows an example process and components involved with securely managing agent operation, according to one embodiment;

FIG. 3 shows an example process and components for securing agent creation/registration, according to one embodiment;

FIG. 4 shows an example process and components for securing agent interaction, according to one embodiment;

FIG. 5 shows an example process and components for security and agent operation, according to one embodiment; and

FIG. 6 is a block diagram of an example computer system improved by implementation of the functions, operations, and/or architectures described herein.

### DETAILED DESCRIPTION

According to one aspect, the security platform is configured to distinguish between good and bad bots—rather than conventional approaches, which often look to detect and block bots efficiently. Various embodiments of the security platform resolve the need for security, identity, validation, and authentication, and fill the gap where there is no known protocol for validating the “permission to play” of an automated actor on behalf of a user, especially on recurring transactions. Additional implementation solves that same need in the context outside of transaction execution (e.g., permission to access restricted data). Various system components enable standardization of security, identity, validation, and authentication down to a conceptual level, so that consumer onboarding deals with and defines the technical parameters associated with the integration of agent actors.

According to some embodiments, the system can formalize a “contract” between the consumer and the agent that can be used to provide assurance/validation to merchants, and the ability of the merchant to conduct further SCA (either directly via the agent, the bank (3DS) or direct to the user). In various examples, the system is configured to enable end users to define agents that operate on their behalf, define the constraints of the agent's operations, and ensure security configuration meets the threshold requirements of any participant who will receive or execute agent-based operations, among other options. Technical configurations and requirements become encoded as such “contracts” that enable the system to enforce technical constraints, monitoring conditions, and various thresholds associated with differential security conditions (e.g., a first level of identity assurance for repeated actions/operations, a second level for new or less common operations, value based enhancement of security parameters, specific merchant security targets and/or requirements, among other options.).

Examples of the methods, devices, and systems discussed herein are not limited in application to the details of construction and the arrangement of components set forth in the following description or illustrated in the accompanying drawings. The methods and systems are capable of implementation in other embodiments and of being practiced or of being carried out in various ways. Examples of specific implementations are provided herein for illustrative purposes only and are not intended to be limiting. In particular, acts, components, elements, and features discussed in connection with any one or more examples are not intended to be excluded from a similar role in any other examples.

Also, the phraseology and terminology used herein are for the purpose of description and should not be regarded as limiting. Any references to examples, embodiments, components, elements, or acts of the systems and methods herein referred to in the singular may also embrace embodiments including a plurality, and any references in plural to any embodiment, component, element, or act herein may also embrace embodiments including only a singularity. References in the singular or plural form are not intended to limit the presently disclosed systems or methods, their components, acts, or elements. The use herein of “including,” “comprising,” “having,” “containing,” “involving,” and variations thereof is meant to encompass the items listed thereafter and equivalents thereof as well as additional items. References to “or” may be construed as inclusive so that any terms described using “or” may indicate any of a single, more than one, and all of the described terms.

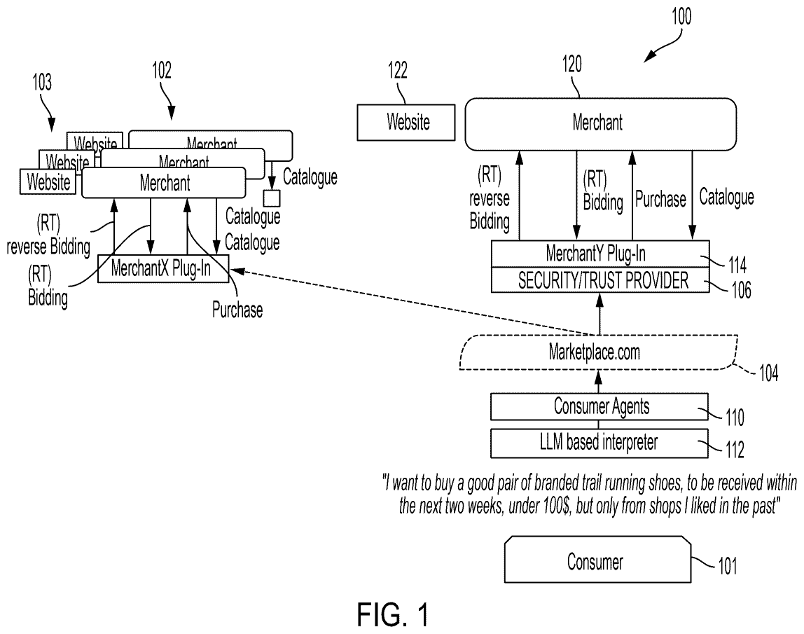

FIG. 1 is an example block diagram 100 of an example system and environment in which an agent may execute operations on behalf of an end user. According to some embodiments, an end user may include a consumer agent 110 who interacts with their system (e.g., via an LLM-based interpreter 112) to authorize, create, or register agents (e.g., 110) that will automatically act on behalf of the end user (e.g., 101). According to one example, an end user can include a consumer who defines consumer agents that will operate on his or her behalf when interacting with various websites (e.g., marketplace platforms—104).

According to some embodiments, the marketplace platform (e.g., 104) may be associated with a plurality of merchants (e.g., 102) and respective sites (e.g., 103). As discussed herein, the ability of the marketplace platform and associated systems to verify the authenticity, security, and validity of such agent operations is provided by interaction with a security/trust provider 106. In some embodiments, the security/trust provider 106 can be implemented as a separate component or can be accessed via an API or plug-in (e.g., 114). In some examples, the plug-in or API can be specific to a merchant or may interact or access a marketplace platform (e.g., 104). According to some embodiments, API or plug-in integration can be leveraged as part of registration/creation of specific agents and targeted/linked merchants.

In further example, creation of an agent can include participation or requirements executed on behalf of respective merchants, and the merchant's understanding and/or assurance that agents are identifiable or verifiable to a required level of assurance, and/or constrained to ensure only authorized operation (and any constraints) is permitted. FIG. 1 details the interaction between a specific merchant plug-in (e.g., 114) and a respective one (e.g., 120) of the merchants associated with the platform. As discussed, each merchant (e.g., 120) can be associated with their own respective website (e.g., 122), and may also be associated with a platform that provides access to a plurality of merchants.

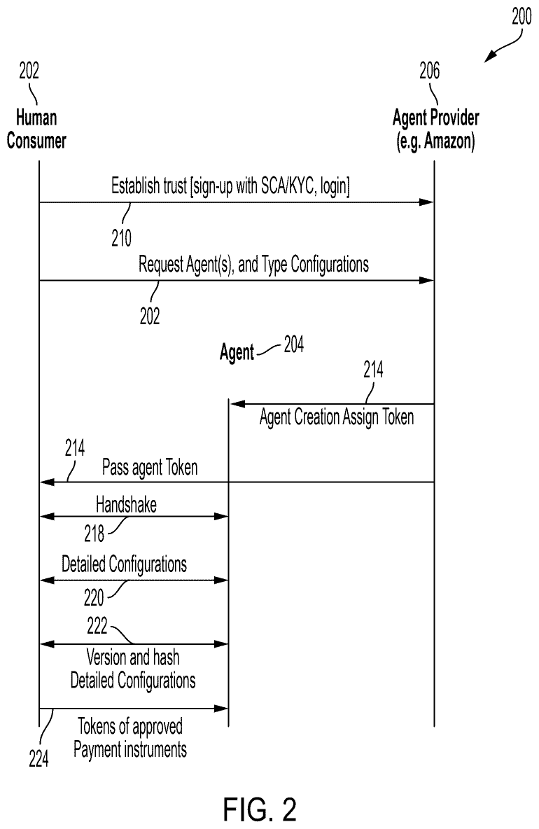

FIG. 2 shows an example process 200 and components involved with registering an agent, creating, or provisioning an agent. As shown in FIG. 2, a human consumer can access an end-user component 202 to interact with an agent provider 206 to define, register, or create an executable agent, which may be run on an agent component 204. The authorization can be tailored and/or customized to a strength defined by or respective by specific participants. As shown, the process flow begins at 210 with an establishment of trust or determination of identity and authorization. According to some embodiments, the operations to establish trust can include a sign up with secure customer authentication (“SCA”) or know your customer systems (“KYC”), or login via an authentication or security process.

In various examples, the flow ensures that the trust step at 210 requires an authentication strong enough to be respected or validated by other participants in an operation execution. For example, a base level of assurance/authentication can include defining a minimum level of authentication or security required that meets the strictest standard of any participant in an operational environment (e.g., shown in FIG. 1). Process 200 continues at 212 with definition or creation of a specific agent and optional configurations of an agent type that may specify what specific operations or participants a given agent may interact with (e.g., data retrieval agent, security agent, management agent, purchasing agent, among other options). Registration and creation of the agent can be specific to a merchant, a group of merchants, or a platform having a plurality of merchants. The preceding can establish the base level of identity assurance/verification that the system is configured to implement in subsequent agent-controlled operations. In some examples, agent registration/creation may include tailoring (e.g., authorizing) the agent to a respective API or plug-in associated with a merchant, group, or platform, among other options.

At 214, as part of agent creation, a token is assigned to a specific agent, which can occur as part of interactions with an agent component (e.g., 204). As shown in FIG. 2, at 216, an agent provider system can pass the agent token to the end user's system. In other examples (not shown), the agent token can pass from the provider system to an agent system and from the agent system to the end user. Once the end user system has the token, a handshake or security process can be executed at 218 for the generation of detailed configurations at 220.

For example, detailed configurations include for example, permissions for ops and their constraints, [e.g., frequencies of ops], reputation of connection, and approved external entities the agent can interact with, among other options. In some examples, the detailed configurations can include specific permissions associated with specific operations and may include defining constraints, for example, on an operation-by-operation basis. In other examples, constraints can include a frequency threshold for executing operations by the agent, among other options.

In some embodiments, detailed configurations can include a reputation of the connection between the agent and its creator/requester, and the reputation information can be used when assessing the validity of a request made by respective agents for respective operations. In still other embodiments, the detailed configurations can include a whitelist of approved external entities an agent can interact with and may include such a whitelist on an operation-by-operation basis as well as a general approved approach for multiple operations. Some examples include blacklisted entities that prohibit a created or registered agent from requesting operations from specific parties.

Once the agent and detailed configurations are set at 220, a version of the agent can be captured with a hash of all the detailed configurations at 222. In some examples, process 200 includes capturing a signature of an agent and associated configurations to enable subsequent validation of requests or operation execution (e.g., at 22). In some embodiments, process 200 can include associating tokens of approved payment instruments with a given agent at 224. In some examples, this enables the agent to use, for example, wallets to transact on behalf of humans, even as a guest checkout, where the usage with the merchant can be emulation of the human purchasing with the payment instrument, among other options. According to some examples, associating these tokens at 224 enables a respective agent to use payment modalities (e.g., wallets) to execute transactions on behalf of the end user who created or requested them, among other options. In other examples, agents may be executed even in the context of an unidentified operator (e.g., as a guest check out). In further embodiments, agent execution and interaction, for example, with a merchant, can be an emulation of a human purchasing with a specific payment instrument.

It should be understood that communication and execution between the participants in FIG. 2 can occur in conjunction, simultaneously, and/or be combined. In still other embodiments, the components 202, 204, and 206 may be implemented as separate systems, or can be implemented as respective elements on common systems, or a hybridization of either option. In various embodiments, after executing agent creation processes, the agent is capable of autonomously communicating with end-users, and the agent provider component (e.g., 206) can execute the agent itself.

In some examples, the agent token is a shared secret (e.g., symmetric, asymmetric, etc.) between the agent component and a manager system component (e.g., the human or another agent). For example, the hash of various information (e.g., agent token plus next token plus external entity (e.g., merchant) ID, among other options) is encoded as the shared secret that allows the external entity to attest or validate a link between and executing agent and the end user who created the agent to operate on their behalf.

In some embodiments, the process 200 may be chained/repeated so that the human consumer and system (e.g., 202) can be replaced by an agent creating new agents. In various embodiments, an agent can be created and authorized to create further agents to operate on behalf of an end-user. Each such agent created in this fashion adopts or is associated with the identity and assurance information of the end user who initiated the process. In yet other embodiments, the steps associated with handling payment instruments and encoding approved payment instruments as part of agent creation can be executed via updates to a wallet's interface (e.g., via API) or other interactions with a payment modality and control systems.

Example considerations addressed by various embodiments can include any one or more or any combination of: after this agent creation phase, agent is capable of autonomously communicating with the user (e.g., with various implementation examples-the Agent Provider component can also operates/execute the agent); the agent token is a secret shared (e.g., Symmetric, asymmetric, etc.) between agent and manager component (e.g., human or another agent); For example, the hash of [agent token+next tokens up to the human+external entity (e.g. merchant) ID], is the secret shared with the external entity to attest the link between the agent and the human; in some embodiments, the process described here may be chained/repeated with the human replaced by an agent-agents can be authorized to create agents; the process of handing payment instruments like wallets to the agent (left bottom) involves updating the wallet's interface (e.g., via API) to allow this.

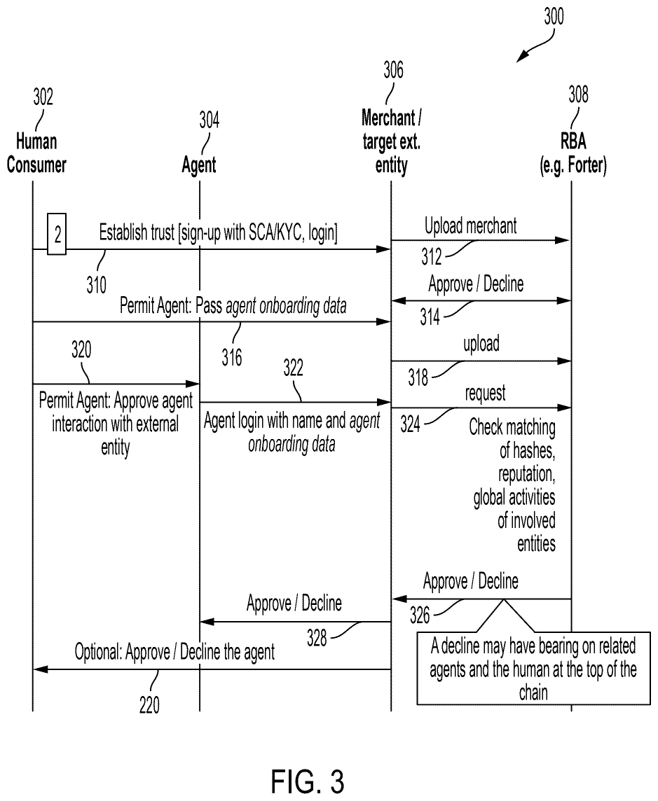

FIG. 3 is an example process flow 300 illustrating system components for agent onboarding with an external entity. According to some embodiments, an external entity may be a merchant, an auction house, a bid aggregator, or another entity that will execute agent operations, and/or interact with an agent to accomplish specific operations on behalf of an end user.

As shown in FIG. 3, various system components may interact to onboard an agent with an external entity. An initial operation to establish trust [sign-up with SCA/KYC, login] can optionally be performed. Process 300 can also begin, for example, with the human consumer accessing an end user system (e.g., 302), interacting with an agent component/system 304, merchant systems (e.g., 306), and/or a risk-based authentication system (e.g., 308). As shown, process 300 can begin at 310 with establishing trust. Establishing trust can include sign up, authentication, or interaction with an SCA or KYC system, and/or may include a login to establish identity and authority. The trust step may be executed between an end-user system 302 and a specific merchant (e.g., 306) or platform. The merchant system can interact with an RBA system at 312 to provide information on an end user and agent onboarding information, among other options (e.g., at 312). The RDA system (e.g., 308) makes an approved/declined determination based on the information provided by the merchant and/or any optional trust information established at 310. In some embodiments, the RBA system (e.g., 308) contains requirements associated with agent operation, the specific merchant, and any constraints on those operations, and may include information on a required level of assurance. If the criteria is met for agent creation (e.g., 314 approved), agent onboarding data can be passed (316) from an end-user system 302 to the merchant system 306, and the onboarding data uploaded at 318 to the RBA (e.g., 308).

During the definition and onboarding of an agent, the end-user system 302 and, for example, the human consumer defines the operations that the agent may execute in association with the external entity at 320. In some examples, this may include the human consumer inputting specific operations and constraints that the agent may operate under or execute on their behalf. As shown, the agent executing on an agent component 304 is now authorized to login on behalf of the end user and with their agent onboarding credentials to a merchant system 306. In response to the agent requesting execution of an operation at the merchant system (e.g., at 324), a request is passed to the RBA system to check the matching of hashes, reputation of the agent, and any associated activities of the involved entities. As shown, the RBA system holds the registry of agents and associated information that includes information on participating merchants and external entities, etc. As part of the operations of the RBA, the RBA system continuously, periodically, or a-periodically accesses the associated information to assign a reputation (e.g., a probability of legitimacy) to the respective agents and/or operations being requested. The RBA system draws reputation information from the end user who created the agent, and also projects reputational information from agent operation onto the associated end user.

According to some embodiments, the request 324 may be approved or declined at 326 based on the assigned reputation/probability of legitimacy, which can be communicated to the merchant systems at 306. This can include any one or more or any combination of a check matching of hashes, reputation, global activities of involved entities, wherein an RBA holds the registry of all agents and their chains as related to all merchants/external entities. The RBA can continuously assess them and assign reputation values (e.g., a probability of legitimacy) to the agents and project this reputation onto associated human actors/users.

As part of the ongoing assessment of reputation, a decline or approval at 326 can be used to alter the reputation of the agent and/or end user associated with the agent or any chain of agents tied to the end user. Process 300 may continue at 328 with communication of an approval or decline to the agent component 304 or to the end user system 302 at 330. In various examples, agent onboarding data can include an agent name, agent parameters, agent hash value, detailed configuration information, agent version, detailed configuration hash, among other options or combinations of the various data. Once an agent is onboarded, the agent can execute its operations autonomously with the external entity (e.g., merchant) in accordance with its constraints defined in the detailed configuration. In some examples, the external entity may or may not verify the legitimacy of the agent's action for each request. The external entity has the information to verify the legitimacy of the agent action, but may instead eliminate these checks and trust the agent to act under the defined configurations and under the reputation of the end user who created them. In various embodiments, any change of an agent's configuration can trigger execution of process 300. For example, any change to an agent configuration may require onboarding with the external entity. In some examples, small changes associated with thresholds for existing operations may be permitted without requiring new onboarding processes.

According to some embodiments, Agent Onboarding Data can include any one or more or any combination of ∘ agent name and params+Agent Hash+Detailed Config.+Version+detailed config hash. After onboarding, the agent is free to act with the external entity (e.g., merchant) per its constraints as set in the detailed config. The external entity may or may not verify the legitimacy of the agent's action (it has them, but may trust the agent to act per their creator's voice). Any change of agent configuration attracts a repeat of the exchange described here. No change to the processing of payment may be imposed, so the process is transparent to the gateway, issuer, acquirer, schemas/networks, PSPs, and payment instruments are still considered bound to humans or legal entities. The RBA may be internal or external to the merchant or mediating entities, or other external entities that require assessment of trust.

According to various embodiments, the use of agents to execute various operations does not result in a change of the processing of the payment operation that would occur if an end user were performing the operation themselves. In essence, existing architecture is still used so that the process is transparent to the gateway, issuer, acquirer, schema/networks, PSPs, and/or other participants in the architecture. For example, payment instruments are still considered bound to the end users or legal entities who have been issued the payment instruments. In various embodiments, the steps shown in process 300 and/or systems shown in FIG. 3 can be combined, executed together, and/or represent internal or external components to individual systems or distributed systems. For example, the RBA can be internal or external to the merchant systems or other mediating entities or other external entities that require an assessment of reputation/trust.

In various embodiments, the system and/or platform can be configured to process a user (e.g., human user) via an onboarding authentication/verification process. In one example, the user's identity is stored along with an authentication level, which can be defined or associated with respective third-party entities. Validation and recordation of identity can include third-party services (e.g., via an identity ledger) or via system-based signature, certificate, hashes, and immutable records, among other options. In some examples, a ledger-based record does not need to be held by a merchant or marketplace (e.g., entities performing the operations (e.g., requested by an agent)). According to various embodiments, the ledger is configured to enable other entities, such as a merchant or a marketplace to access the ledger and/or query it for details stored for a particular user/identity.

In further embodiments, evidentiary records can be maintained for any agent operating in association with the system and/or platform, similar to the user-based records. According to some embodiments, the records can be based on an immutable format (e.g., once validated) and made searchable/accessible to entities who are performing the operations requested by agents. In other embodiments, user and agent-based evidentiary information can be maintained together. In some examples, the agent's identifying information can be incorporated into a ledger (e.g., including verifiable anonymization) for determining the legitimacy/verification of an agent. The agent-based ledger enables other entities, such as a merchant, to query the ledger for details of a particular agent. For example, the ledger may hold trust for classes of agents (e.g., based on the trust assigned to an agent factory (e.g., an agent that creates new agents)) or to particular agent instances.

As discussed above and in various embodiments, the identity and, for example, a public key of the human at the apex of the agent chain (the liable human) can be encoded in the agent records and can be presented to entities interacting with the agent. The inclusion of the public key (or reference to other publicly available validation record) enables the entities processing a request to match a human to the agent request, and evaluate the human against their own entities'store, query about this human with an identities ledger, or contact the human for verification.

In further embodiments, a merchant, marketplace, or identity ledger can reach the human (even if not in real time of the transaction) to authenticate their legitimacy, liability for the interacting agent. In further examples, the human user can validate their intent to have the agent perform specific operations and/or classes of operations. In one example, a human user can be requested to approve a groceries agent, when an intent criteria is exceeded. In one example, the platform can determine that a groceries agent has requested an operation to purchase diamonds. The system can then request a confirmation that the diamond purchase is indeed fulfilling the human user's intentions.

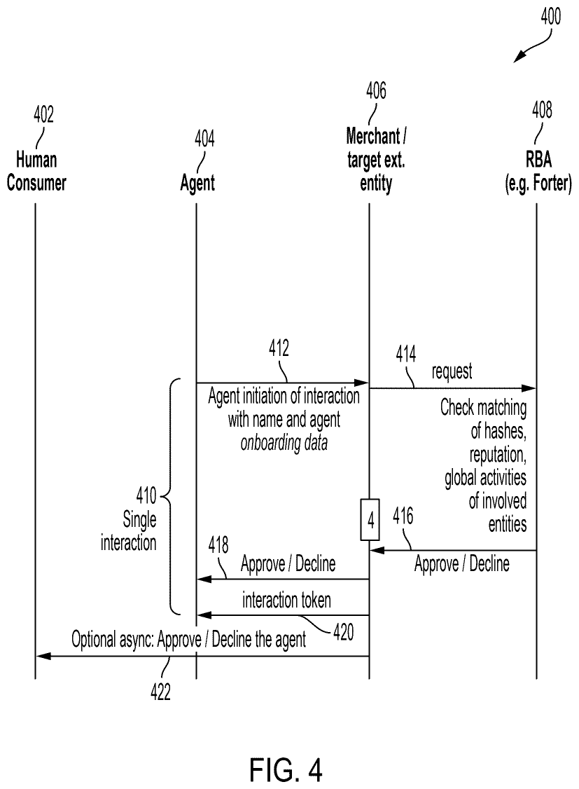

FIG. 4 is an example process flow 400 illustrating system components for agent interaction with an external entity. According to some embodiments, an external entity may be a merchant, an auction house, a bid aggregator, or another entity that will execute agent operations, and/or interact with an agent to accomplish specific operations on behalf of an end user.

As shown in FIG. 4, various system components may interact to onboard an agent with an external entity. For example, the human consumer can access an end user system (e.g., 402), can interact with an agent component/system 404, merchant systems (e.g., 406), Risk-Based Authentication system (e.g., 408). As shown, process 400 can begin at 410 with establishing trust. Establishing trust can include sign up, authentication, or interaction with an SCA or KYC system, and/or may include a specific login to establish identity and authority. The trust up may be executed between an end-user system 402 and a specific merchant (e.g., 406) or platform.

As shown in FIG. 4, process 400 can begin at 412 with agent initiation of an operation or interaction with another system in the architecture. The initiation of the operation 412 can include an agent name and agent onboarding data communicated, for example, to a merchant system 406. According to various embodiments, agents may control or execute single interactions with downstream systems, shown at 410. In other embodiments, agents may control multiple operations and manage multiple interactions with downstream systems. In the illustrated flow, once the merchant system receives the interaction and onboarding data, the merchant system can forward a request to the RBA system (e.g., 408) by communicating a request at 414. The RBA system checks to confirm that there is a matching of hashed information, sufficient reputation, and to account for any global activities of the involved entities that may impact a determination of reputation and/or authorization to perform the operation or interaction requested. At 416, the RBA system returns an approve or decline message to the merchant system 406, and the merchant system can pass the approve/decline information at 418 to a respective agent component based on an interaction token (e.g., 420). Optionally, or in the alternative, an unapproved/declined message can be passed from the merchant directly to an end user system or component at 422.

According to some embodiments, accessing the human, who may well be offline during interaction, is initiated with optional async notification (e.g., 422). The merchant, or its RBA, can also trigger step-up (e.g., increased security) to the payment instrument owner (e.g., [3DS “out of band challenge”])

According to some embodiments, the interaction token persists throughout the interaction that could be lengthy (for example, a bid process that spans from part of a second to days). In some examples, no changes to the configuration affecting the interaction are possible during interaction based on system constraints. The token can be used to enable the trusted exchange of data during the interactions.

According to some embodiments, an interaction token can be produced as part of process 400 that governs the execution of any interaction or operation and may persist over a lengthy period of time. For example, if an agent requests execution of a bid process (a bid can span a single second or multiple days), a single interaction token may be generated that persists throughout the bid process. In various embodiments, the generation and verification of hash information ensures that no changes to a configuration occur that would affect a given interaction when the interaction/operation is underway. In other embodiments, the system may permit some changes in updating information so long as the updated information (e.g., signatures or hashes) is confirmed with the respective systems so that the updated information can, in fact, be verified. In various embodiments, the interaction token is used during the execution of process 400 to enable the trusted exchange of data between the various system elements or components. The specific exchange of information is not shown in the process flow but can be accomplished as part of or in conjunction with the steps illustrated.

In various embodiments, process 400 can be configured to account for end users who are offline during the timing of the operation or interaction requested by an agent. The awareness of the state of the end user can be relevant if, during an interaction, a step up in authentication privileges is requested by one of the participants in the architecture. For example, a merchant or an RBA can trigger a request for further authentication or a step up in authentication privileges in response to an operation or execution request initiated by the agent. This may occur as part of a 3DS out-of-band challenge. The system is configured to accept asynchronous information in response to such out-of-band challenges to accommodate offline entities associated with the agent requesting an operation or interaction.

According to various embodiments, the RDA system 408 is configured to update the evaluation of reputation for the agent even during the execution of an operation or interaction. The updates may be the result of changes in information associated with the end user who created the agent or associated with the agents themselves, as well as other agents associated with an agent requesting the operation or interaction. In other examples, additional factors may impact the reputation of a given agent, the end user, or any connected agents, and may play a role in the determination of sufficient reputation to permit an operation or interaction to occur. According to various embodiments, an interaction may be any action permitted by an agent's detailed configuration. For example, these interactions may include any combination of the following: login, payment, payment transaction, inquiry on stock, registration for a bid, execution of a bid, registration to merchant communication (e.g., private or public), declaration of a reverse bid, announcing results of reverse bid, among other options. In various embodiments, interactions can include multiple sessions or communications with respective systems over a material time span—which can be governed by specific configurations when an agent is created. Example considerations can include any one or more or any combination of: the human may be offline in time of interaction; the RBA may update its opinion about the agent (e.g., reputation) due to changes to its knowledge about the human or the agents upstream or the agents downstream or other factors in the agent's environment; interaction may be any action permitted by the agent's detailed configuration-for example, but not limited to: login, payment transaction, inquiry of stock, registration to a bid, bidding, registration to merchant public or private announcements, declaring a reverse bid, announcing results of reverse bid, which can persist for several sessions with material time span, among other options.

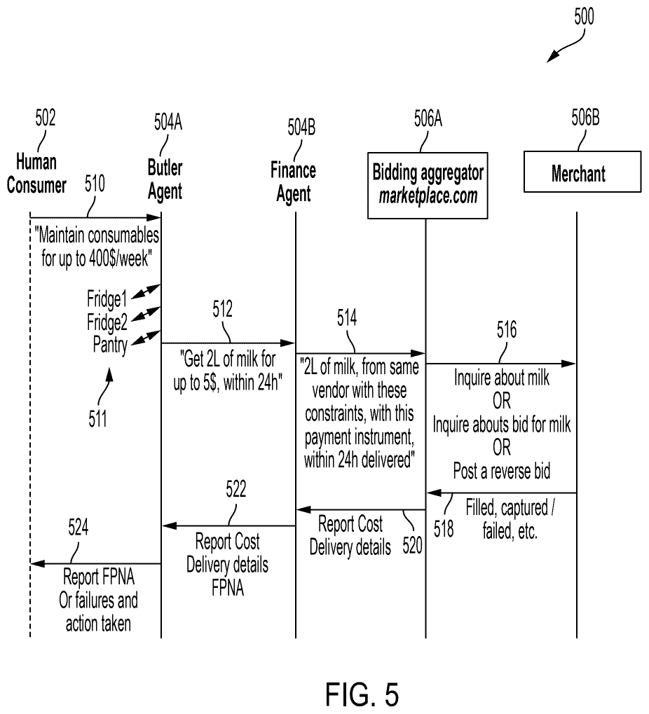

FIG. 5 is an example process flow 500 illustrating system components for agent chain reputation. Process 500 illustrates operations between agents and systems and eliminates description of RBA interaction, handshakes, and other authentication processes to focus on chain reputation as a vehicle for ensuring trust or authorization for executing operations.

According to one embodiment, an end-user system (e.g., 502) can be used to define operations to be executed by an agent (e.g., 504A). In this example, the end user (e.g., human consumer) has created a butler (e.g., 504A) that is configured to manage shopping on behalf of the end user. The butler agent 504A can be configured to interact with various intelligent appliances, retrieve information on associated tasks (e.g., availability of groceries, consumables, etc.), and execute operations automatically based on retrieved information or other inputs. As shown in process 500, the butler agent 504A is configured to determine when an action is required and request a specific action to be executed by a chained agent 504B. In this example, the chained agent is a finance agent 504B, that is configured to receive instructions from the butler agent 504A and interact with a marketplace platform or specific merchant (e.g., 506A or 506B). In various embodiments, the chaining of agents is associated with security and trust for the respective agents. In one example, the security permission and authority generated by a human user as part of the agent creation becomes the foundation of trust and equivalent security permission/authentication for downstream or chained agents. Each member of the chain becomes a representative of the other with respect to all activity taking place within the architecture. Thus, a fraud indicator generated by the human user can directly impact the trust level associated with any, and each, agent connected to that human user. Further, a fraud indicator generated from actions by any agent in the chain likewise can directly impact the human user's trust level/security level.

As shown in FIG. 5, process 500 begins at 510 with the definition of a specific target goal or constraint that the agent is responsible for maintaining.

This can include “Maintain consumables for up to 400$/week” or other detailed configs (e.g., constraints) that include specification of vendors, fallback if impossible, payment instruments, etc. As discussed above, the agent interacts with a variety of intelligent appliances (e.g., 511 fridge 1, fridge 2, pantry sensor or systems, or pantry inventory systems, among other examples). Based on information collected by the butler agent 504A, the agent creates a request to get 2 L of milk and provides specific constraints on the operation (e.g., up to five dollars and within 24 hours) at 512. As shown, the butler agent 504A communicates the specific construction constraints to the finance agent 504B. The finance agent 504B connects with a bidding aggregator or marketplace platform at 514 to perform the operation under the specific constraints. The bracket reflects the duration of these actors'interaction. In some examples, no config changes are allowed within the interaction based on system constraints.

Optionally, a bidding aggregator or marketplace platform may be connected to a plurality of merchants (e.g., 506B) that convey the request from 514 as an inquiry or query about milk or about bids for milk or to post a reverse bid at 516. In other embodiments, the finance agent may connect directly to a merchant and post a bid or reverse bid, or even execute a purchase with the respective merchant.

Once the inquiry generated at 516 is satisfied, and assuming the constraints fall within the returned information, the order or request can be executed at 518, or an indication that the request failed may also be returned. At 520, a detailed receipt for the operation is generated to specify the specific details under which the operation was executed and/or to confirm delivery details associated with the requested operation. The report costs/delivery detail information can be passed from the finance agent to the Butler agent at 522. The Butler agent can be configured to generate summary reports on financial planning and analysis where the operations the agent is in charge of deal with inventory management, consumable management, among other options. If, instead, the operation resulted in failure, the reporter notification at 524 can indicate the result.

In further example (not illustrated): the human in one example creates all the agents under her (no chaining of creation and definition of roles), but agents can request creation of agents, e.g., if it's in the allowed actions in their config, and pass to them detail config which is a concrete and specific interpretation of their own config.

Various embodiments and implementations can include any one or more, or any combination, of the following outlined features:
I. Example Security Protocol: Onboarding
   a. Protocol defines the formal process of onboarding a consumer (e.g., agent setup)
   b. Consumer onboarding process (e.g., Forter can serve as the agent RBA provider) includes email/phone. Includes granting the agent specific permission regarding operations and constraints:
   c. Add payment method to agent (optional Risk Assessment/SCA) [optional]
   d. Define [optional] profile permissions/preferences to conduct automated payments. For example:
      i. Recurring constraint preferences: up to X payments, up to Y amount
      ii. Security preference (e.g., agent to trigger confirmation/step up verification on every transaction, on every X purchases/days)
      iii. Experience preferences—intelligence enables the agent, for example, to sign up to a site for additional discounts
      iv. Other context-driven rules for permission to act, which are proxies of the suitability of the action the agent is permitted to take, or of the probability that the human would like the action to be taken. For example: other activities of the human, location of the human, etc.
II. Creating the Transaction Contract
   a. The consumer creates a new “contract” with the automated agent—these constraints become encoded as technical aspects of the agents, and for example, made immutable via hashes or other shared secrets. Some examples include fixing in blockchain encoded blocks (e.g., private chain instances and/or public chain in obfuscated form.
   b. As part of the constraint creation, a Risk engine determines if there is a need for SCA. The encoded permissions enable:
      i. A one-time use payment method (SCA can be triggered for risk (in case of suspicious activity) or convenience (in case this is a scheduled payment and the consumer will be “offline” later). An indicator for it can be used as part of TX.
      ii. recurring operation execution (e.g., fridge to restock me weekly)
      iii. The security platform creates an identification certificate that is passed to the merchant, providing evidence of user authentication and allowing for SCA if needed.
III. The transaction authentication protocol allows for two-way authentication as needed.
   a. High Level—The agent presents the TX details to the merchant plus an encrypted certificate as defined by the protocol to identify the consumer, agent, and contract terms (e.g., encrypt data such as when contract was initiated, when the last user Strongly authenticated approval for contract was given, the form of the SCA conducted, details about the agent, User login credential to allow “registered” TX, user sign up details to enroll)
   b. For example, encrypted certification can be set to expire after a time period, a number of uses, or $$ amount of a transaction.
   c. The merchant Risk engine can trigger step up (e.g., SCA) directly for the user, e.g., via email/phone passed from the agent. For example, using a second communication channel (e.g., out-of-band messaging, text, e-mail, voice call, etc.).
   d. The merchant Risk engine can trigger a step up to the payment instrument owner [e.g., 3DS “out of band challenge”].
   e. Agent being the trusted entity for triggering the authentication (acting in a similar role to the bank in 3DS, this can be configured to take away control from the bank). In some examples, this changes conventional approaches so that agents can mediate improved authentication, the system leverages configurations that make the end user more comfortable, and also means less transaction failure for lack of response. The result is improved operation for the whole architecture as well as improved security, for example, by tying agent action to a user security profile, and in further example, by holding agent actors accountable for any respective action they take, approve, mediate, and/or initiate.
   f. Merchant Risk engine is configured to determine which challenge is triggered to avoid cumbersome end-user friction (potentially at least the three challenges noted above happening simultaneously).
IV. Not onboarded identification of agent
   a. Identify agent versus human
      i. Indicators: Dwell time, operation execution timing, consistency with prior actions, etc.
   b. Agent persona linking provides options for protecting operation with a non-registered agent (e.g., based on probability linking to a registered agent (e.g., a human set up another agent), strength of security/trust reduced based on unregistered status;
      i. Profile behavior of “good” agents and “bad” agents
         1. Use profile to allow or increase security/trust evaluation for operations, among other options
   c. Profile behavior of “good” agents and “bad” agents
      i. Use profile to allow transaction/operation, or increase security requests for operations

Further aspects allow for extended transaction completion timing—unlikely in the context of many POS transactions (e.g., purchases, sales, etc.) where a transaction is either allowed or denied when executed—however, agent-based operations or transactions do not typically involve a person waiting for completion, thus there is an opportunity for extended transaction completion timing, enabling security in a context where conventional approaches do not permit simply by extending the timing for completion. Since in some examples this is asynchronous authentication, where the user is not necessarily in front of the agent, the merchant can determine how long they want to hold the inventory for and share this data with the agent. The response to the agent should also be a structured set of constraints (e.g., sample data can include: confirmation, step up security request, information such as inventory to be held for X days, additional questions to the consumer, such as add-on products, grant marketing notifications, etc.).

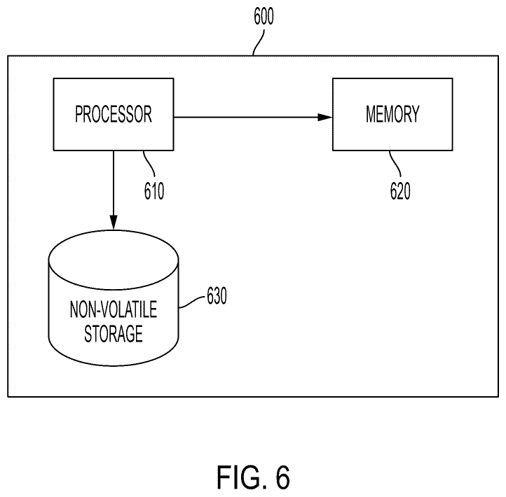

FIG. 6 is a block diagram of an example computer system that is improved by implementing the functions, operations, and/or architectures described herein. Conventional systems target agents or bots with the goal of preventing their operation, and under the conventional wisdom of improving security by identifying and disabling bot operation. The disclosed platform takes the opposite approach, providing specific identities to agent-based operations to ensure a baseline security/trust level is met whenever they operate. Additional features not found in conventional approaches include any one or more of the following: securing agent identity to the operations they request, linking a base security/trust identity to any member of chain of creator and multiple agents that may even be created by other agents in the chain, tracking each agent and their creator's activity to update respective security/trust information for the chain, implementing specific constraints on the operation(s) each agent can perform, updating a security profile based on the specific constraints implemented, and even enforcing automatically by the system inclusions of default constraints on agents/operations based on the operations requested, architecture participants and respective requirements (e.g., a merchant may require that agents can only be authorized when total risk exposure is below a threshold (e.g., maximum spend threshold, maximum per operation threshold, etc.), linking agent versions to immutable properties for ensuring compliance with the forgoing among other options discussion herein. These technical features and implementation provide new functionality not contemplated by conventional approaches, and further, when used in various combinations, yield new security features unavailable in conventional approaches.

Modifications and variations of the discussed embodiments will be apparent to those of ordinary skill in the art, and all such modifications and variations are included within the scope of the appended claims. Additionally, an illustrative implementation of a computer system 600 that may be used in connection with any of the embodiments of the disclosure provided herein is shown in FIG. 6. The computer system 600 may include one or more processors 610 and one or more articles of manufacture that comprise non-transitory computer-readable storage media (e.g., memory 620 and one or more non-volatile storage media 630). The processor 610 may control writing data to and reading data from the memory 620 and the non-volatile storage device 630 in any suitable manner. To perform any of the functionality described herein (e.g., image reconstruction, anomaly detection, etc.), the processor 610 may execute one or more processor-executable instructions stored in one or more non-transitory computer-readable storage media (e.g., the memory 620), which may serve as non-transitory computer-readable storage media storing processor-executable instructions for execution by the processor 610.

The terms “program” or “software” are used herein in a generic sense to refer to any type of computer code or set of processor-executable instructions that can be employed to program a computer or other processor to implement various aspects of embodiments as discussed above. Additionally, it should be appreciated that according to one aspect, one or more computer programs that when executed perform methods of the disclosure provided herein need not reside on a single computer or processor, but may be distributed in a modular fashion among different computers or processors to implement various aspects of the disclosure provided herein.

Processor-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in one or more non-transitory computer-readable storage media in any suitable form. For simplicity of illustration, data structures may be shown to have fields that are related through location in the data structure. Such relationships may likewise be achieved by assigning storage for the fields with locations in a non-transitory computer-readable medium that conveys relationships between the fields. However, any suitable mechanism may be used to establish relationships among information in fields of a data structure, including through the use of pointers, tags, or other mechanisms that establish relationships among data elements.

Also, various inventive concepts may be embodied as one or more processes, of which examples (e.g., the processes described herein) have been provided. The acts performed as part of each process may be ordered in any suitable way. Accordingly, embodiments may be constructed in which acts are performed in an order different than illustrated, which may include performing some acts simultaneously, even though shown as sequential acts in illustrative embodiments.

In other embodiments, various ones of the functions and/or portions of the flows discussed herein can be executed in a different order. In still other embodiments, various ones of the functions and/or portions of the flow can be omitted or consolidated. In yet other embodiments, various ones of the functions and/or portions of the flow can be combined, and used in various combinations of the disclosed flows, portions of flows, and/or individual functions. In various examples, various ones of the screens, functions, and/or algorithms can be combined, and can be used in various combinations of the disclosed functions.

### Example Chain Permission Implementation

For example, a device like Alexa can initiate a transaction/call/operation, thus humans are not necessarily the ones who are buying. There may be a chain of agents and delegated permissions, and the system integrates permission, trust, or security linkage throughout the chain as well as updates to each member of the chain. Further examples and implementation can enable an interface to the merchants to obtain consent for agents'permissioned operation or to secure execution via chained operation.
Assumed for the system is that the consumer would not be interacting with a single merchant or event, but rather the system/architecture needs to support trust for an agent managing your ongoing operations (e.g., context of a smart refrigerator—for buying groceries). In various embodiments, the agent's operations become like a recurring payment or some sort of guidance that a current request is similar to trust/reputation/authentication previously provided to end-point systems (e.g., the merchants) in a similar operation.
Example—tell the agent, buy milk today, find the best price for something specific (e.g., milk). Interestingly, this type of agent need not be AI, but the security considerations remain the same. The system allows delegations and creation of rules, and specifies how each participant in a transaction execution or data operation works and is verified.
Generative AI can be involved in the natural language interface in such operations.
Some embodiments allow for procedural, or rule-based, agents and verification/validation. Further embodiments identify AI integration for validity and verification as well.
Various aspects provide for the use of bots/agents who may operate under rule-based constraints or may operate under AI-based constraints, validating them and developing a trust proposition for the bot/agent or in whatever authority chain they might be in.

### Example Middleware Implementation (e.g., Operation Network Participants)

Various embodiments manage secure execution via middleware systems and monitoring. For example, specific protocols can be defined between the agent and the merchant interface. In further example, system plugins (e.g., browser-based, platform-executed APIs, etc.) can be invoked to monitor and validate operations.
RBAs as participants in the transaction/operation architecture can be tasked with various identification, validation, trust assertion, and/or verification procedures. In further embodiments, the various components of the middleware system become a host for defining such operational security, assurance, and/or security enhancement requests.
   Can include combinations of:
      Onboarding (e.g., when you sign up to a play store and you get permissions right) and definition of rules/responsibility. The system can then turn such a definition into specific technical operators to monitor and manage execution flow.
         E.g., when a computer invokes SSL, you deliver/grant permissions, like initiation. Similarly, SSO invokes certification or prior authentication. By granting such authority, agents can be given operating constraints and/or authority to act (e.g., within boundaries). Once permission is given, there is a token in many cases, which, from most security perspectives, is not going to necessarily be sufficient (and may even include regulatory requirements in the future). The technical framework for evolving security parameters is managed by various embodiments. For example, each participant in the processing chain can be defined and have their own security requirements executed during processing.
      Having the ability to create permissions for the participants (e.g., merchant, user, RBA, processors, payment providers, etc.) is provided by the system and framework. In some examples, such permission might not even be used to immediately—and may not be permitted for perpetual things (e.g., agent instructions to buy me my weekly groceries, participant can reach out to her this week and not reach out to Instacart next week, and reach out to Instacart only when such a such restriction (e.g., re-auth every two weeks) is triggered to the surface).

### Example Refresh Rules Implementation (Technical Constraint Generation & Requirements Used to Build Specific Technical Constraints on Operation)

The auth token (e.g., which is being refreshed according to timing constraints). For example, the auth token is not necessarily as severe as perpetual, and can be restricted by time, by frequency, and/or by amounts.
At least two scenarios: one where the reputation is used, or our repeat date, and we allow only participants to be able to give access to only particular levels of execution.
Satisfaction can also be managed in the sense that the easy learning to secure machine learning by the merchants: how and to what degree that you are really satisfied with their purchases or with their actions—conventionally merchants leave this management alone
token refresh terms—managed machine-to-machine
   Ensure end-user final consent: there are multiple paths here. One is formalized via the agent or an Alexa app. Enhanced security request—user states: “Alexa, please authorize this.” Security system and/or framework allows Alexa to authorize (e.g., in response to an enhanced security request), for example, is the request one to turn on lights (e.g., in the same space as the request is received from, among other examples).
Refrigerator example: this commerce site provides a user/viewer app—agent triggers Alexa (e.g., app) (assume Whole Foods—an Amazon partner), determines a need to complete the purchase via Instacart. Now the system needs to validate, ensure protection for Instacart interaction. Instacart can require the engagement to follow their rules, and say require under a threshold dollar grocery order or reject (in another example—require additional security when exceeding the threshold).
   E.g., seamless 3DS Like obligation
      There's an issuer, there's the merchant, and there is the end user. At the end of the day, the issuer, although they're not interacting specifically with the viewer, is able to trigger a notification to the end user to confirm it is not an anomaly or not provision this or we do not facilitate this operation.
      Security review is saying on evaluation: this order may seem quite legitimate, or may seem quite suspicious. Maybe there's a high frequency of orders from this account. The system and architecture provide the ability to trigger a mechanism that actually engages the end user to confirm or pre-arrange sufficient validation, and/or provide other mechanisms for sufficient validation.
      For example, leverage the payment method. MFA required by payment may be enough validation, for example. As part of the contract definition, the technical implementation can rely on other security requirements (e.g., the payment method can trigger MFA and close the loop). And the third is actually to leverage the agent to provide that which is potentially the best experience if a user has an Alexa order groceries. Then Alexa can verify with the user—“Are the orders ready?” “Please confirm.” User—“Confirmed.” In this example, voice or device or biometric confirmation provides the validation for that specific agent action so that the end user cannot later repudiate or be surprised by the charges. The merchant can even receive data associated with such confirmation (e.g., if later disputes arise).
      The system provides assurance (e.g., evidence) that has been personally approved
      The financial agent authorized the list of agents, and financial agents are setting the rules for all interests.

### Example Authentication Implementation—Authentication Includes

delegated even the permission scheme or the permission configuration versions
delegated authority & delegated confirmation.

### Example Delegated Permissions

delegated permissions to an application and the AI agent via the equivalent of an App Store: type mechanism, configuration of the permission, and/or delegation itself
Chains of agents involves a level of complexity not contemplated nor address in current art: fridge example or the Alexa example, give permission via my Alexa and once a user gives it, with associated device and with user's voice—now the system can propagate permission down downstream to newly created agents (created by agents).
nested permissions configuration—including, for example, a few weeks after the same time that the order should be fulfilled.
weekly recurring example—not looking at a specific order, like get it to my house Friday. Instead, determining by the system order happened last week and now happens again this week, and so on—here the system defines the ability of the agents to actually send verification information for this operation that is tied to the original.
   Here, the merchant does not need to maintain any connection persistence of the session (e.g., a conventional limitation). No need for a persistent session, or a persistent session is unrelated to the ability of the agents that the system can establish as connected (optionally confirm or authenticate as well).

### Example System Permission and Monitoring Implementation

The system ensures getting permissions and maintaining them, which satisfies the matrix of requirements defined by all the participants in the operational chain, e.g., this merchant knows the agent and is authorized because the system ensured the user did the initial delegation (e.g., the human did the initial delegation for the region). The agent can even provide a fingerprint/certificate for the operation
Examples where a token is not enough: within the context of the token world, the token verifies an agent. But the agent cannot present for the certification any new set of permissions. The permissions need to come from a higher authority, not from the agency in this relationship, so the system needs to see how a human actor gives permissions for someone who works under delegation to change solutions, essentially to expire the token.
The system is configured to expire permissions (e.g., tokens) but also enable modification of permissions (e.g., elevated authority, reduced authority, different triggers for confirmation, or enhanced security requirements, etc.).

Further, the system enables operations under the notion of progressive deviation, meaning that for some merchants or for some users go either way (in terms of allowing, denying, or enhancing security). The system can permit operations for a threshold number of interactions (e.g., the first three interactions). Similarly—KYC on various platforms (e.g., like stripe), the system does need to take any action for a threshold number of actions or total value (e.g., 4 actions or $1,000, etc.) and then the system is configured to deny or enhance once the thresholds are exceeded—alternatively if the operations, value, or requests match bad actor patterns, deny or security enhancements can be triggered, accordingly.
In further embodiments, the system secures operations that enable a merchant or its RBA service (or in other examples, any external authorized broker or agent) to access the human for further verification of the agent that acts on behalf of the human. For example, the handshake (e.g., information exchanged) for an agent with an external entity can be configured to contain the details for establishing contact/handshake with the human, or in other examples, to enable communication with the entity from which the authority to act was delegated to the agent. In some embodiments, the external entity, such as a merchant or broker, can trigger a security protocol that uses these contact details to climb the delegation chain up to a point of sufficient authority (e.g., where the external entity is provided validation/authentication assurance that the higher entity was well authenticated). In some examples, the system enables security escalation for agent operation, which enables the system to provide verification of the agent's identity and the agent's delegated authority details.

Having thus described several aspects of at least one example, it is to be appreciated that various alterations, modifications, and improvements will readily occur to those skilled in the art. For instance, examples disclosed herein may also be used in other contexts. Such alterations, modifications, and improvements are intended to be part of this disclosure, and are intended to be within the scope of the examples discussed herein. Accordingly, the foregoing description and drawings are by way of example only.

All definitions, as defined and used herein, should be understood to control over dictionary definitions, and/or ordinary meanings of the defined terms. As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

Use of ordinal terms such as “first,” “second,” “third,” etc., in the claims to modify a claim element does not by itself connote any priority, precedence, or order of one claim element over another or the temporal order in which acts of a method are performed. Such terms are used merely as labels to distinguish one claim element having a certain name from another element having a same name (but for use of the ordinal term).

The phraseology and terminology used herein is for the purpose of description and should not be regarded as limiting. The use of “including,” “comprising,” “having,” “containing”, “involving”, and variations thereof, is meant to encompass the items listed thereafter and additional items.

Having described several embodiments of the techniques described herein in detail, various modifications, and improvements will readily occur to those skilled in the art. Such modifications and improvements are intended to be within the spirit and scope of the disclosure. Accordingly, the foregoing description is by way of example only, and is not intended as limiting. The techniques are limited only as defined by the following claims and the equivalents thereto.

What is claimed is:

1. A system for secure authentication protocols for agent-based operations, the system comprising:
at least one processor operatively connected to a memory, the at least one processor when executing, is configured to:
identify a secure operation initiated by an agent;
evaluate at least one security requirement associated with the secure operation, based on at least one or any combination of: the secure operation, identification of the agent, security association between the agent and a human actor, merchant, payment modality, value associated with the secure operation, and sensitivity of the secure operation; and
confirm the at least one security requirement is met or trigger enhanced security requests to meet the at least one security requirement.

2. The system of claim 1, wherein the at least one processor is configured to:
evaluate a signature or certificate associated with the agent; and
retrieve or confirm secure operation constraints based on the signature or certificate.

3. The system of claim 2, wherein the at least one processor is configured to retrieve the signature or the certificate associated with the agent, wherein the signature or the certificate encodes a defined security level associated with the agent and version of the agent.

4. The system of claim 3, wherein the signature or the certificate associated with the agent immutably encodes any authorized operation associated with the agent and operational constraints imposed on the authorized operation.

5. The system of claim 1, wherein the at least one processor is configured to evaluate a timing associated with a last threshold level of authentication.

6. The system of claim 1, wherein the at least one processor is configured to evaluate respective participant requirements in an execution architecture against a defined security level associated with the agent, any authorized operation associated with the agent, and operation constraints imposed on the authorized operation to determine compliance with the participant requirements.

7. The system of claim 6, wherein the at least one processor is configured to evaluate a first set of requirements imposed by a first set of participants in an execution architecture for a first agent configured to operate with the first set of participants.

8. The system of claim 7, wherein the at least one processor is configured to evaluate a second set of requirements imposed by a second set of participants in the execution architecture for a second agent configured to operate with the second set of participants.

9. The system of claim 7 or 8, wherein a respective agent is linked to a respective set of participants via a plugin or API connecting the respective agent to at least one member of the respective set of participants.

10. The system of claim 1, wherein the at least one processor is configured to trigger enhanced security requests to meet the at least one security requirement.

11. The system of claim 10, wherein the at least one processor is configured to evaluate a chain of permissions for the agent operation from the agent to respective preceding delegations until a security threshold is met.

12. A computer-implemented method for secure authentication of agent-based operations, the method comprising:
identifying, by at least one processor, a secure operation initiated by an agent;
evaluating, by at least one processor, at least one security requirement associated with the secure operation, based on at least one or any combination of: the secure operation, identification of the agent, security association between the agent and a human actor, merchant, payment modality, value associated with the secure operation, and sensitivity of the secure operation; and
confirming, by the at least one processor, the at least one security requirement is met, or triggering enhanced security requests to meet the at least one security requirement.

13. The method of claim 12, wherein the method comprises:
evaluating a signature or certificate associated with the agent; and
retrieving or confirming secure operation constraints based on the signature or certificate.

14. The method of claim 13, wherein the method comprises retrieving the signature or the certificate associated with the agent, wherein the signature or the certificate encodes a defined security level associated with the agent and a version of the agent.

15. The method of claim 14, wherein the signature or the certificate associated with the agent immutably encodes any authorized operation associated with the agent and operational constraints imposed on the authorized operation.

16. The method of claim 12, wherein the method comprises evaluating a timing associated with a last threshold level of authentication.

17. The method of claim 12, wherein the method comprises evaluating respective participant requirements in an execution architecture against a defined security level associated with the agent, any authorized operation associated with the agent, and operation constraints imposed on the authorized operation to determine compliance with the participant requirements.

18. The method of claim 17, wherein the method comprises evaluating a first set of requirements imposed by a first set of participants in an execution architecture for a first agent configured to operate with the first set of participants.

19. The method of claim 18, wherein the method comprises evaluating a second set of requirements imposed by a second set of participants in the execution architecture for a second agent configured to operate with the second set of participants.

20. The method of claim 18, wherein a respective agent is linked to a respective set of participants via a plugin or API connecting the respective agent to at least one member of the respective set of participants.

21. The method of claim 12, wherein the method comprises triggering enhanced security requests to meet the at least one security requirement.

22. The method of claim 21, wherein the method comprises evaluating a chain of permissions for the agent operation from the agent to respective preceding delegations until a security threshold is met.
